(19) United States
(12) Patent Application Publication
(10) Pub. No.: US 2004/0019806 A1
(43) Pub. Date: Jan. 29, 2004

(54) Securing a remote command call using a security protocol

(75) Inventor: Yehia S. Beyh, Groton, MA (US)

Correspondence Address: IP Administration, Legal Dept. M/S 35, Hewlett-Packard Com., P.O. Box 272400, Fort Collins, CO, 80527-2400, US

(73) Assignee: Compaq Information Technologies Group, L.P., Houston, TX

(21) Appl. No.: 10/207,654

(22) Filed: Jul. 26, 2002

(51) Int. Cl. H04L 9/00

(52) U.S. Cl. 713/201

(57) ABSTRACT

Improved methods and related apparatus and computer program products for integrating a security protocol into existing network environments are disclosed. A method of establishing secure communication between a client and server computer on a network comprises the steps of intercepting certain calls issued by the client, and substituting a security library for a working library of the client, the security library enabling operation of the call using a predefined security protocol. The certain calls can be, for instance, calls from a client application to a common library function in the working library of the client, such as the rcmd function, to establish a conventional unsecure network connection. The calling applications could include the r*utilities (rsh, rlogin, and rcp), or other applications which call rcmd to establish network connection. The security library enables operation of the call using a predefined security protocol, such as a secure shell (SSH) security protocol. In particular embodiments, the security protocol provides for encryption of data transmitted between the client and the server.

### BACKGROUND OF THE INVENTION

Security has become a major concern for computer network communications. In recent years, new security protocols have been introduced to secure network connections by encrypting passwords and other data. An example of one such security protocol is the Secure Shell (SSH) protocol, which provides strong authentication and secure communications over insecure computer networks.

The SSH protocol is designed to protect connections and data transfers between computers on a network from third-party attacks. SSH provides strong authentication using public-key algorithms (e.g. Diffie-Helman Key Exchange and Digital Signal Algorithm), which helps to prevent spoofing, session hijacking, and man-in-the-middle attacks. In addition, SSH helps avoid eavesdropping by encrypting the connection even before the user sends their remote username to the server over the wire.

The SSH protocol is designed to be a complete replacement for many legacy applications and utilities commonly used to establish network connections and to transfer data between a client and a server, such as the well-known r*utilities (e.g. rsh, rlogin, and rcp). The r*utilities establish a network connection via the rcmd routine. Relative to the SSH protocol, the rcmd does not provide a high level of security for data transmitted between two machines on a network. For instance, the rcmd routine does not provide for the encryption of any data passed along the wire, including potentially sensitive data, such as usernames and passwords, which may be required in order to establish the network connection. Thus, the current rcmd routine, and the r*utlilities which employ this routine, may be an unsatisfactory solution for users who demand a high level of security for network communications.

### SUMMARY OF THE INVENTION

The integration of a robust security protocol, such as SSH, into existing network environments has proven problematic. One common method is to simply replace existing legacy applications like the r*utilities by creating a “symbolic link” to the SSH client program. Using a symbolic link, for example, all calls to the r*utilities (i.e. rsh, rlogin, and rcp) automatically turn into SSH connections. However, using a symbolic link can result in a host of configurational problems. Also, because a symbolic link effectively removes the legacy applications, the investment in these applications is lost.

In addition, symbolic linking will only be effective if all remote connections use the particular utilities which form the symbolic link to SSH. In many cases, though, there may be legacy applications which directly call the rcmd library function. In this situation, the connection would still be unsecure.

Another approach to securing legacy applications is to alter the code for the applications themselves in order to fully make use of the integrated SSH support. This is not an ideal solution either, as it is time-consuming and expensive to implement these changes.

Accordingly, the present invention relates to improved methods and systems for integrating a security protocol into an existing network environment. In one aspect, for example, the present invention is directed to a method of establishing secure communication between a client and server computer on a network, the method comprising the steps of intercepting certain calls issued by the client, and substituting a security library for a working library of the client, the security library enabling operation of the issued call using a predefined security protocol. The certain calls can be, for instance, calls from a client application to a common library function in the working library of the client, such as the rcmd function, to establish a conventional unsecure network connection. The calling applications could include the r*utilities (rsh, rlogin, and rcp), or other applications which call rcmd to establish network connection. According to one embodiment, the call to the rcmd function in the client's working library is intercepted, and a security library is substituted for the working library. The security library enables operation of the call using a predefined security protocol, such as a secure shell (SSH) security protocol. In particular embodiments, the security protocol provides for encryption of data transmitted between the client and the server.

The invention method can further include the step of determining whether the client and/or the server supports operation of the intercepted call using the predefined security protocol. This could include, for instance, checking a client configuration file to determine whether operation of the intercepted call using the predefined security protocol is enabled. If this operation is enabled, then the security library is substituted for the working library of the client. If this operation is not enabled, then the call can proceed to the working library of the client, and the remote connection can be established using a conventional library function, such as rcmd. In a preferred embodiment, the client configuration file can be configured by a network administrator on a user-specific or system-wide level.

The step of determining whether the server supports operation of the intercepted call using the predefined security protocol could include, for instance, establishing a low-level connection between the client and the server to determine whether the server supports operation of the call using the security protocol. If the server does support this operation, then the security library is substituted for the working library of the client. If, however, the server does not support this operation, then the call can proceed to the working library of the client, and the remote connection can be established using a conventional library function, such as rcmd.

In other aspects, the present invention includes a computer apparatus and a computer program product for establishing secure network communications substantially as described above.

The present invention provides improved methods, apparatus, and computer program products for integrating a security protocol into existing network environments. The invention advantageously provides added security for network communications without requiring costly and time-consuming code changes to legacy applications which currently employ a standard library function for establishing unsecure network connections. The invention can also enable a system administrator to easily enable and enforce the use of a comprehensive security protocol across an entire network. Furthermore, the invention provides increased flexibility in choosing the appropriate level of security for particular types of network communications without requiring substantial code changes to the underlying secuity protocol software.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1. is a schematic illustration of a computer network including at least two computers connected by a communication link;

FIG. 2 is a schematic block diagram of an unsecure network connection between a client and a server;

FIG. 3 is a schematic block diagram of a secure network connection between a client and a server according to one aspect of the invention;

FIGS. 4A and 4B are flow diagrams illustrating the process steps for establishing a secure network connection according to one embodiment of the invention; and

FIG. 5 is a flow diagram showing the scrmd server process steps according to another aspect of the invention.

### DETAILED DESCRIPTION OF THE INVENTION

A description of preferred embodiments of the invention follows.

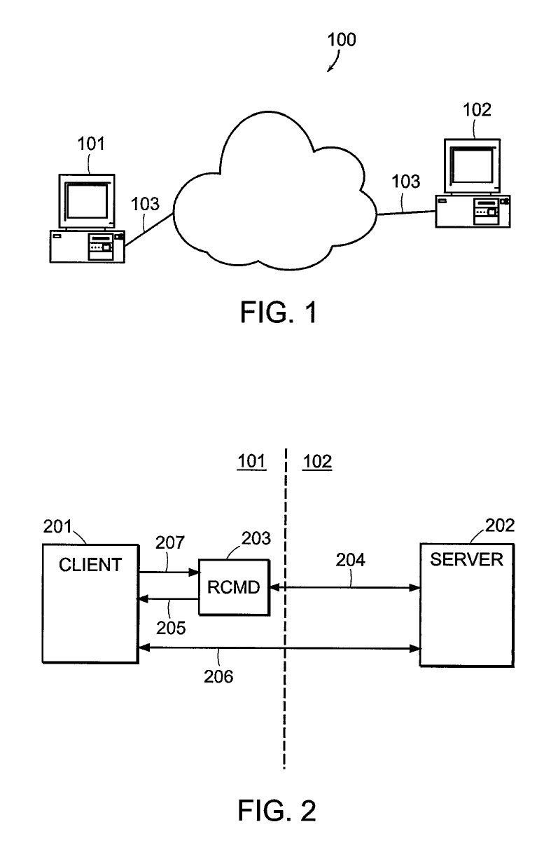

FIG. 1 shows a network 100 comprising a plurality of computers 101, 102 connected by a communication link 103. The computers generally exist in a client/server relationship, where at least one computer 101 runs a client program (herafter referred to as the client computer), and at least one other computer 102 runs a server program (hereafter referred to as the server computer). It will be understood that a particular computer may at various times act as both a client computer and as a server computer relative to other computers on the network.

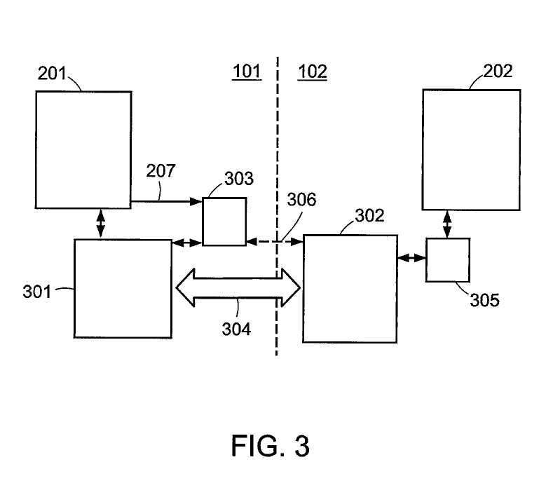

FIG. 2 is a schematic diagram illustrating an unsecured network connection between a client 101 and a server 102. The client computer 101 runs client application programs 201 which make service requests to a server program 202 located on a remote host 102. These service requests might include, for example, requests to create a session on the host computer 102, to copy or transfer files between the two computers, or to execute a command on the host computer 102. Examples of client applications 201 making remote requests include the well-known r*utilities (e.g., rsh, rlogin, and rcp).

Before the client application 201 can issue its remote request to the server program 202, it must first establish a connection with the remote host. A typical routine for establishing an usecured connection is shown schematically in FIG. 2. In general, the application program 201 issues a call 207 to a standard library function 203 to establish the network connection to the target host 102. In the present example, the library function is the rcmd function 203. This is a common function used by a number of client applications (such as rsh, rlogin, and rep) to establish the connection to the server 102. Rcmd is a standard function found in the working library (e.g. libc) of a number of operating systems, including the Tru64™ UNIX operating system from Compaq, Inc.

In a typical implementation, as shown in FIG. 2, the client application 201 issues a call 207 to the rcmd function 203, passing data to the rcmd (such as the host, the local user, the remote user, the remote port, and a request for a file descriptor for standard error). Using this data, the rcmd function 203 then requests a network connection to the server program 202 across a remote communications link 204. The rcmd function 203 creates a data file descriptor using an unused privileged (512 to 1024) network port. Once the connection is established to the target host, rcmd tells the server program 202 to use yet another privileged port to accept standard error (if the client has requested it). The rcmd function 203 then writes the data (local user, remote user, and command) to the data file descriptor. It then verifies the remote connection to ensure that it is still active by reading data sent by the server program 202 (e.g. stdin/stdout/stderr). If the connection is verified, the rcmd function 203 returns to the client a file descriptor 205 for a network port 206 that the client application 201 can use to transmit data to the server program 202. The rcmd function 203 can optionally return a second file descriptor to read standard error (sdterr). If the connection to the server program 202 is not verified, then rcmd 203 closes all file descriptors and returns a failure value (e.g. negative one).

If the connection is successful, the client application 201 may then communicate directly with the server program 202 using the file descriptor 205 for a network port 206 returned by rcmd function 203.

The rcmd routine 203 thus creates a network communication link (i.e. a network socket) between the client and server applications 201, 202, but does not provide means for securing the data transmitted across the wire. As a consequence, network connections created by the standard rcmd function can be vulnerable to third-party attacks.

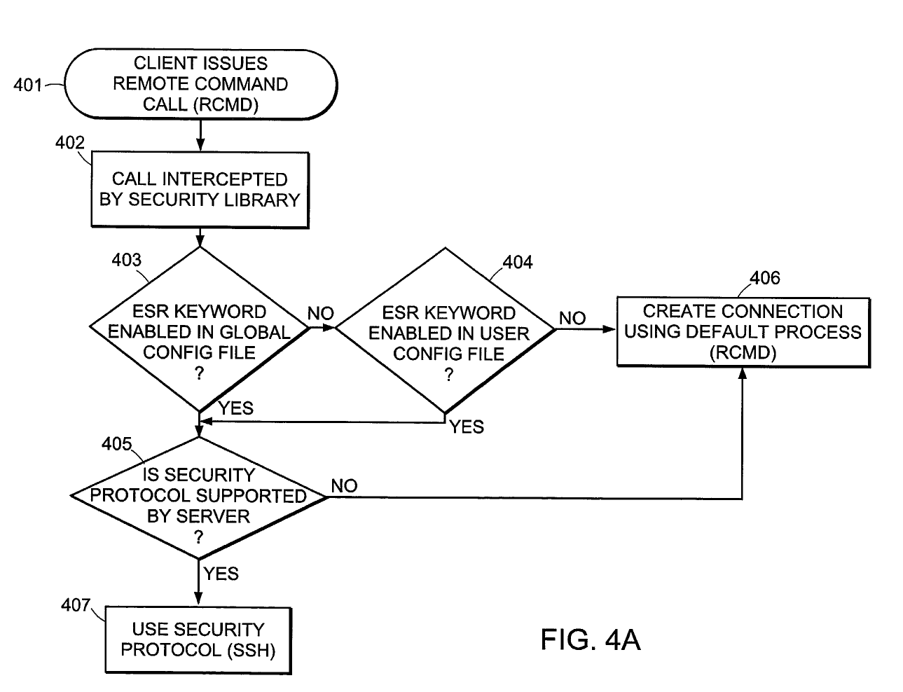

FIG. 3 is a schematic block diagram of a secure network connection in accordance with one aspect of the present invention. In this embodiment, as in FIG. 2, a client application program 201 makes a service request to a server program 202 located on a remote host 102. The client applications 201 can be the same as those discussed in connection with FIG. 2, (such as rsh, rlogin, and rcp), as well as other applications which make service requests to the server program 202, including requests to create a session on the server computer 102, requests to copy or transfer files to between the client and server computers 101, 102, or requests to execute a command on the server computer 102. The client applications 201 issue calls to a standard library function located in the working library of the client, such as the rcmd function, to establish a network connection to the server program 202.

In the embodiment shown in FIG. 3, however, the call to the standard library function is intercepted by security library 303 (which for convenience will be referred to as libsshrcmd.so). The security library 303 acts as a “hook” in the standard working library of the client application 201, and determines what kind of connection (secure or unsecure) will be made between the client and the server applications 201, 202. More particularly, the security library 303 can include a first function/routine (which for convenience will be referred to as use_secure_rcmd) for determining whether or not the network connection will be secure, and a second function/routine (which for convenience will be referred to as ssh_rcmd) for establishing a secure network connection using SSH or a similar security protocol.

If the security library 303 determines that the connection will be unsecure, then the call to the rcmd function proceeds to the working library of the client application 201, and the connection to the server program 202 is made substantially as shown and described in connection with FIG. 2.

If the security library 303 determines that the connection will be a secure connection, then the connection is made using a predefined security protocol. In the embodiment shown in FIG. 3, the connection is made using a Secure Shell (SSH) security protocol. More particularly, the security library 303 can include a second function/routine (ssh rcmd) for creating a Secure Shell connection between the client and server applications 201, 202.

In a preferred embodiment of the invention, a particular SSH feature known as port forwarding or “tunneling” is used to create the secure SSH session. This feature allows an ordinary remote session to be secured via strong authentication, encryption, and integrity checking. The port forwarding feature provides a secure “tunnel” through which another (unsecure) connection may pass. Thus, the client and server applications 201,202 can execute their normal routines for establishing an (unsecure) TCP/IP connection between one another. However, the TCP/IP connection itself is secured within the tunnel created between an SSH client 301 and an SSH daemon server 302. All of the sensitive data required to establish the network connection between the client application 201 and the server program 202 (such as usemames and passwords) is encrypted at the client-end by SSH 301 before it is passed along the wire to the server 202. As none of this data is sent in the clear, the network is much less vulnerable to third-party attacks.

As illustrated in FIG. 3, the client application 201 passes its data to the local SSH connection with the SSH client 301 as if it were passing its data to a remote data connection stream. The SSH layer encrypts the data and sends it in a secure channel 304 to the SSH server 302 (i.e. sshd). The SSH server 304 decrypts the data and passes it to the server application 202 via a local TCP/IP connection. The secure shell “tunnel” is transparent to the client and server applications. However, once the SSH session has been established, none of the data between the client and server applications 201, 202 is sent “in the clear.”

The SSH local port forwarding allows the use of any available unprivileged port (between 1024 and 65,535). The port forwarding is typically enabled or specified during the creation of the SSH session. Once the session has been created, the SSH client process 301 listens on the local port (e.g. 127.0.0.1, port). When the client application 201 connects to the forwarded port, SSH creates a new channel (i.e. a logical stream) which protects the data stream (i.e. input, output, and error). The SSH server process 302 initiates a TCP connection to the target port, thus establishing a secure channel for client/server applications transparently.

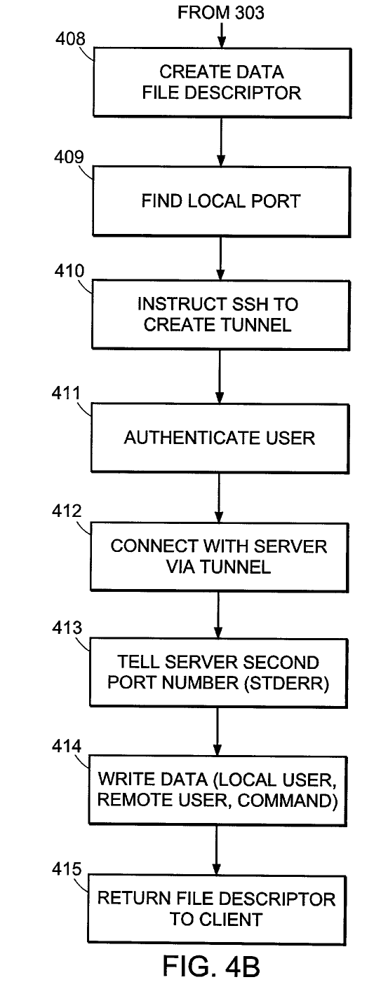

FIGS. 4A and 4B are flow diagrams illustrating the process steps for establishing a secure connection in the network shown and described in FIG. 3. FIG. 4A shows the steps for determining whether or not the network connection will be secure. In the embodiment shown in FIG. 3, for example, these steps can be performed by the use_secure_rcmd routine located in security library 303.

The process is initiated at step 401 when a client application 201 issues a call to a standard library function of a working library of the client, (such as the rcmd function), to establish a network connection to the server program 202. At step 402, this call is intercepted by security library 303, which determines whether or not the network connection will be secure.

At step 403, the use_secure_rcmd routine checks the configuration files for the security protocol (such as the SSH protocol) to see if the security protocol is enabled to secure the remote utilities on the local host. According to one embodiment, the routine checks the client global configuration files for the value of a security protocol keyword (which for convenience will be referred to as “EnforceSecureRutils”). The use_secure_rcmd routine can call a subroutine (which for convenience will be referred to as rcmd_check_conf_file) to check the value of the keyword.

If the value of the EnforceSecureRutils keyword is set to “yes” in the global configuration file, then the use_secure_rcmd routine proceeds to step 405 to determine whether the security protocol is supported by the target host. If the EnforceSecureRutils keyword is set to “no” in the client global configuration files, then the routine proceeds to step 404 to check the user-specific security protocol (e.g. SSH) configuration file. If the client global configuration files do not exist, then the routine proceeds to step 406, and an unsecure network connection is established using a standard function (such as rcmd) located in the working library of the client.

At step 404, the routine checks the value of the EnforceSecureRutils keyword in the user-specific security protocol configuration file. If the user-specific configuration file is not available, or if the value of the keyword is set to “no,” then the routine proceeds to step 406, and an unsecure network connection is established. If the value of the keyword is set to “yes,” then the routine proceeds to step 405 to determine whether the security protocol is supported by the target host.

If the EnforceSecureRutils keyword is set to “yes” in the global or user-specific configuration files, then the routine proceeds to step 405 to determine whether the security protocol is enabled on the target host. In one embodiment, the use_secure_rcmd routine calls a subroutine (which for convenience will be referred to as rcmd_check_ssh_connection) to determine whether the security protocol, such as an SSH security protocol, is supported by the target host. In one example, the rcmd_check_ssh_connection routine establishes a low-end TCP connection to the target SSH server (shown as 302 in FIG. 3). If this connection is successful, rcmd_check_ssh_connection then checks for the server's version of the security protocol software for compatibility with the client's version. If the connection is not successful, or if the server's version of the security protocol is not compatible with the client's version, then the routine proceeds to step 406, and an unsecure network connection is established using a standard library function. If the security protocol exists on the server, and the versions are compatible, then the routine proceeds to step 407 to establish a secure connection to the server using the security protocol. In either case, the low-end connection to the server is closed.

FIG. 4B shows the steps for establishing a secure network connection between the client and the server. In the embodiment shown in FIG. 3, for example, these steps can be performed by the ssh_rcmd routine located in security library 303. In general, the ssh_rcmd routine instructs the SSH client application 301 to create a Secure Shell connection 304, authenticates the user to SSH, and returns at least one file descriptor for a network socket to the client application 201.

At step 408, for example, the ssh_rcmd routine creates a first socket or data file descriptor. The routine then finds an unused local port (between 1024 and 65,535) at step 409. At step 410, the routine instructs the SSH client program (302 in FIG. 3) to create a local port forwarding connection (i.e. an SSH tunnel 304) to the SSH server program 302 (i.e. sshd). In order to create the SSH tunnel 304, the routine authenticates the user at step 411. In general, the authentication used to secure the socket is set by the SSH protocol.

At step 412, the ssh_rcmd routine connects with the server application (202 in FIG. 3) via the SSH “tunnel” or forwarded port. If the client asks for a second file descriptor (for sderr), the routine then creates a second socket for a privileged port, and informs the server application 202 this port number at step 413.

At step 414, ssh_rcmd writes the data passed by the calling application (i.e. local user, remote user, and command) to the server application 202, and confirms connection to the server application 202. If the connection to the remote server is a success, ssh_rcmd returns the file descriptor(s) to the calling client application 201 at step 415. The client application 201 can now use the file descriptor(s) to communicate directly with the server application 202 through the secure SSH tunnel 304. If ssh_rcmd is unsuccessful in creating the secure connection (for instance, SSH was unable to authenticate the user or create the tunnel, or ssh_rcmd was unable to write the remote command), then a failure value is returned to the calling application 201.

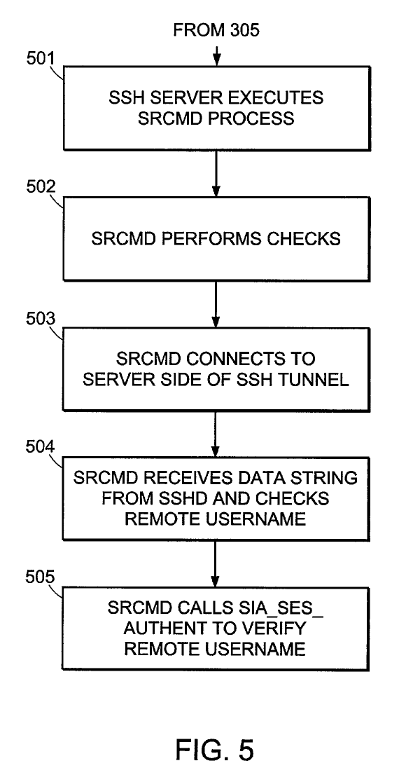

Turning again to FIG. 3, the server 102 additionally includes a server process, srcmd 305, which communicates with the SSH server, sshd 302, and the server application 202. This server process 305 is similar to the r*utilities' daemons (i.e. rshd and rlogind) and is intended to solve the server-side requirements of the remote utilities. FIG. 5 is a flow diagram showing the scrmd server process 305 steps. At step 501, the SSH server, sshd 302, detects an incoming connection to a forwarded TCP port of port number 513 (login) or port number 514 (shell), and executes an srcmd process as the user that was authenticated by sshd. At step 502, srcmd performs a series of checks to ensure that only the authenticated user that started the tunnel 304 can connect to the process. In particular, srcmd 305 verifies that the parent process is indeed sshd, and that the socket is bound from the local host to the sshd daemon.

Once srcmd 305 completes these two checks, srcmd 305 establishes a connection to the server-side (sshd) of the SSH tunnel 304 at step 503. At step 504, srcmd receives the ssh_rcmd data string (local username, remote username, command) from sshd 302, and checks the remote username to see if it matches the username of the srcmd process 305 (which had been authenticated by sshd). At step 505, a final check is made to confirm the user's identity by calling the sia_ses_authent routine to ensure that the remote usemame is coming from the data that sshd 302 passed to the srcmd server process 305. The sia_ses_authent routine verifies that the user has all the needed privileges to be making the remote connection.

While this invention has been particularly shown and described with references to preferred embodiments thereof, it will be understood by those skilled in the art that various changes in form and details may be made therein without departing from the scope of the invention encompassed by the appended claims.

What is claimed is:

1. In a computer network having a client computer and a server computer, a method of establishing secure communications between the client and server, comprising the steps of:
intercepting certain calls issued by the client; and
substituting a security library for a working library of the client, the security library enabling operation of the calls using a predefined security protocol.

2. The method of claim 1, wherein the step of intercepting includes intercepting command calls from the client to the server.

3. The method of claim 1,wherein the step of substituting further includes:
providing a secure connection between the client and server for transmitting encrypted data between the client and the server.

4. The method of claim 3, further comprising:
at one of the client and server,
(i) receiving transmitted encrypted data; and
(ii) decrypting the received data.

5. The method of claim 1, wherein the predefined security protocol is a Secure Shell security protocol.

6. The method of claim 1, wherein the command call comprises a call to an rcmd function in the working library.

7. The method of claim 1, wherein the certain calls are issued by at least one of rsh, rlogin, and rcp utilities.

8. The method of claim 1, further comprising:
after intercepting the call, determining whether at least one of the client and the server supports operation of the intercepted call using the predefined security protocol.

9. The method of claim 8, wherein the step of determining comprises:
checking a client configuration file to determine whether operation of the intercepted call using the predefined security protocol is enabled, and substituting the security library for a working library of the client where operation of the intercepted call using the predefined security protocol is enabled.

10. The method of claim 8, wherein the step of determining comprises:
determining whether the server supports operation of the call using the predefined security protocol, and substituting the security library for a working library of the client where the server supports operation of the call using the predefined security protocol.

11. The method of claim 10, further comprising:
establishing a low-level connection between the client and server to determine whether the server supports operation of the call using a predefined security protocol.

12. The method of claim 1, further comprising:
reconfiguring the security library to enable operation of the certain calls using a different predefined security protocol.

13. A computer apparatus enabling secure communications between a client computer and a server computer, comprising:
means for intercepting certain calls issued by the client; and
means for substituting a security library for a working library of the client, the security library enabling operation of the certain calls using a predefined security protocol.

14. The computer apparatus of claim 13, further comprising:
a client application issuing the certain calls, the certain calls including command calls from the client to the server.

15. The computer apparatus of claim 13, wherein the client application comprises at least one of rsh, rlogin, and rcp.

16. The computer apparatus of claim 13, wherein the predefined security protocol is a Secure Shell security protocol.

17. The computer apparatus of claim 13, wherein the command call comprises a call to an rcmd function in the working library.

18. The computer apparatus of claim 13, further comprising:
means for determining whether at least one of the client and the server supports operation of the call using a predefined security protocol; and
means for substituting a security library for the working library based upon the determination.

19. The computer apparatus of claim 18, wherein the means for determining comprises:
means for checking a client configuration file to determine whether operation of the intercepted call using the predefined security protocol is enabled, and substituting the security library for a working library of the client where operation of the intercepted call using the predefined security protocol is enabled.

20. The computer apparatus of claim 18, wherein the means for determining comprises:
means for determining whether the server supports operation of the call using the predefined security protocol, and substituting the security library for a working library of the client where the server supports operation of the call using the predefined security protocol.

21. The computer apparatus of claim 20, wherein the means for determining includes means for establishing a low-level connection between the client and the server.

22. The computer apparatus of claim 13, wherein the predetermined security protocol provides a secure connection between the client and server for transmission of encrypted data between the client and the server.

23. The computer apparatus of claim 22, further comprising:
at one of the client and server,
(i) means for receiving transmitted encrypted data;
(ii) means for decrypting the received data.

24. A computer program product for establishing secure connections between a client computer and a server computer in a computer network, the computer program product comprising a computer usable medium having computer readable program code thereon, comprising:
program code for intercepting certain calls issued by the client; and
program code for substituting a security library for a working library of the client, the security library enabling operation of the certain calls using a predefined security protocol.

25. The computer program product of claim 24, wherein the certain calls include command calls from the client to the server.

26. The computer program product of claim 24, wherein the certain calls are issued by at least one of rsh, rlogin, and rcp utilities.

27. The computer program product of claim 25, wherein the command call comprises an rcmd function in the working library of the client.

28. The computer program product of claim 24, wherein the predefined security protocol is a Secure Shell security protocol.

29. The computer program product of claim 24, further comprising:
program code for determining whether at least one of the client and the server supports operation of the certain commands using the predefined security protocol; and
program code for substituting the substituting the security library for the working library of the client based upon the determination.

30. The computer program product of claim 29, wherein the program code for determining comprises:
program code for checking a client configuration file to determine whether operation of the intercepted call using the predefined security protocol is enabled, and substituting the security library for a working library of the client where operation of the intercepted call using the predefined security protocol is enabled.

31. The computer program product of claim 29, wherein the program code for determining comprises:
program code for determining whether the server supports operation of the call using the predefined security protocol, and substituting the security library for a working library of the client where the server supports operation of the call using the predefined security protocol.

32. The computer product of claim 32, further comprising:
program code for establishing a low-level connection between the client and the server to determine whether the server supports operation of the certain commands with the predefined security protocol.
